(19) United States
(12) Patent Application Publication
(10) Pub. No.: US 2026/0127380 A1
(43) Pub. Date: May 7, 2026

(54) Systems and Methods for Intent Based Observability and Control of Artificial Intelligence (AI) Model Interactions

(71) Applicant: WitnessAI, Inc., Incline Village, NV (US)

(72) Inventors: Amr A. Ali, Cairo (EG); Gil Spencer, Incline Village, NV (US); Ahmed Ewais, Cairo (EG); Ibrahim Abdelrahman, Cairo (EG)

(21) Appl. No.: 19/056,582

(22) Filed: Feb. 18, 2025

Related U.S. Application Data
(60) Provisional application No. 63/717,878, filed on Nov. 7, 2024.

(51) Int. Cl. G06F 40/30; G06F 9/54

(52) U.S. Cl. CPC G06F 40/30; G06F 9/54

(57) ABSTRACT

The present disclosure relates to computer security, specifically systems and methods for intent-based observability and control of Artificial Intelligence (AI) model interactions. The described technology addresses the technical problem of insufficient control and observability over AI interactions, which can lead to unauthorized use and security risks. The solution involves a system that classifies user prompts using AI models, such as Large Language Models (LLMs), to determine user intent and applies granular control policies based on this intent. This enables enterprises to manage AI tool usage effectively, ensuring security and compliance. The system captures AI input data, classifies the data to ascertain user intent, and enforces control policies that include filters, rules, and actions. Principal uses include monitoring AI interactions, applying security policies, and preventing misuse of AI tools. The described technology is applicable across various platforms and AI models, enhancing enterprise security and operational efficiency.

### RELATED APPLICATIONS

This patent application claims the priority benefit of U.S. Provisional Patent Application Ser. No. 63/717,878 filed on Nov. 7, 2024, and titled “Systems and Methods for Intent Based Observability and Control of Artificial Intelligence (AI) Model Interactions,” which is hereby incorporated by reference herein in its entirety including all references cited therein.

### FIELD OF THE TECHNOLOGY

The present technology relates to computer security, particularly to systems and methods for intent-based observability and control of Artificial Intelligence (AI) model interactions.

### BACKGROUND

Existing methods for controlling and observing interactions with Artificial Intelligence (AI) models have primarily focused on general monitoring and management of AI systems without specific consideration for user intent. Traditional approaches involve monitoring system performance metrics, such as accuracy and efficiency, to ensure the AI model is functioning as expected. Additionally, some methods utilize predefined rules and thresholds to trigger alerts or actions based on certain conditions or events within the AI system. However, these approaches lack the ability to provide granular control over individual user interactions with the AI model based on the specific intent behind each user input.

In the context of AI systems, the use of Large Language Models (LLMs) has gained popularity for natural language processing tasks. LLMs leverage vast amounts of text data to understand user inputs. Current approaches do not provide a systematic framework for applying fine-grained control policies that include filters, rules, and actions tailored to specific user intents in real-time interactions with AI models.

Moreover, the need for enhanced observability and control over AI model interactions has become increasingly critical as AI technologies are integrated into various applications and services. The ability to interpret user intents accurately and apply precise control policies based on those intents is essential for ensuring the responsible and effective deployment of AI systems.

Existing solutions have not fully addressed the challenges associated with intent-based observability and control of AI model interactions. Therefore, there is a demand for a comprehensive solution that combines intent classification using Artificial Intelligence (AI) models (e.g., LLMs) with granular control policies to enable effective management of user interactions with AI models. None of the previous approaches have provided a comprehensive solution that combines the features described in this disclosure. Consequently, there is a need for a system that can provide intent-based observability and control, enabling enterprises to manage the use of AI model tools effectively while maintaining security and compliance.

### SUMMARY

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

Some embodiments include a computer-implemented method for intent based observability and control of Artificial Intelligence (AI) model interactions, the method including: receiving Artificial Intelligence (AI) input data entered by a user, the Artificial Intelligence (AI) input data including a prompt; classifying the prompt using an Artificial Intelligence (AI) model to determine an intent of the prompt entered by the user; and applying a granular control Artificial Intelligence (AI) policy to the intent of the prompt entered by the user.

In some embodiments the Artificial Intelligence (AI) model includes a Large Language Model (LLM).

In some embodiments the classifying the prompt using the Artificial Intelligence (AI) model to determine the intent of the prompt entered by the user includes fine grained intention classification that provides a precise intent classification of the prompt entered by the user, the Artificial Intelligence (AI) model being a Machine Learning (ML) model.

In some embodiments the classifying the prompt using the Artificial Intelligence (AI) model to determine the intent of the prompt entered by the user includes coarse intention classification that provides a coarse intent classification of the prompt entered by the user by the intent of the prompt being chosen from a predetermined list of intents using the Artificial Intelligence (AI) model, the Artificial Intelligence (AI) model being a Machine Learning (ML) model.

In some embodiments the granular control Artificial Intelligence (AI) policy includes filters, the filters including rules, the rules including actions.

In some embodiments the filters include one or more of: data protection, model protection, and behavioral protection for the Artificial Intelligence (AI) input data including the prompt.

In some embodiments the rules include a block all function, the block all function being blocking all Artificial Intelligence (AI) input data based on the intent of the prompt entered by the user except for an allowed list of specific intentions.

In some embodiments the rules include a allow all function, the allow all function being allowing all Artificial Intelligence (AI) input data based on the intent of the prompt entered by the user except for a non-approved list of specific intentions.

In some embodiments the actions include block the Artificial Intelligence (AI) input data including the prompt based on the intent of the prompt entered by the user.

In some embodiments the actions include allow the Artificial Intelligence (AI) input data including the prompt based on the intent of the prompt entered by the user.

In some embodiments the actions include one or more of: generating a warning and generating an alert based on the intent of the prompt entered by the user.

In some embodiments the actions include one or more of: sending and routing the Artificial Intelligence (AI) input data including the prompt based on the granular control Artificial Intelligence (AI) policy, the sending and the routing being to another specific Artificial Intelligence (AI) model.

In some embodiments the actions include the sending of the Artificial Intelligence (AI) input data including the prompt to security information and event management (SIEM) of an enterprise based on the granular control Artificial Intelligence (AI) policy.

In some embodiments the actions include the routing the Artificial Intelligence (AI) input data including the prompt to a specific Artificial Intelligence (AI) model based on the granular control Artificial Intelligence (AI) policy.

In some embodiments the actions include calling a third-party Application Programming Interface (API) based on the intent of the prompt entered by the user.

Some embodiments of the present technology include further include detecting behavior of the user, the detecting behavior of the user including: determining intent of a plurality of prompts entered by the user; aggregating of the intent of the plurality of prompts entered by the user for the detecting behavior of the user; comparing the behavior of the user to a risk threshold for an enterprise; and generating an enterprise action based on the risk threshold for the enterprise.

Some embodiments include a computer-implemented method for intent based observability and control, the method including: receiving input data entered by a user; classifying the input data entered by the user using an Artificial Intelligence (AI) model to determine an intent of the input data entered by the user, the classifying the input data using a static multiheaded behavior classifier using a single base model, the single base model generating embeddings from input data and allowing for binary verdicts for various behaviors in a single inference pass enabling efficiency and scalability of the classifying the input data; and applying a granular control policy to the intent of the input data entered by the user, the granular control policy including filters, the filters including rules, the rules including actions.

Some embodiments include a computer-implemented method for intent based observability and control, the method including: receiving input data entered by a user; classifying the input data entered by the user using an Artificial Intelligence (AI) model to determine an intent of the input data entered by the user, the classifying the input data using an Adaptive Task Alignment (ATA) Small Language Model (SLM), the Adaptive Task Alignment (ATA) Small Language Model (SLM) processing a plurality of input prompts and aligning the plurality of input prompts with predefined categories, thereby enabling precise intent classification, efficiency, and scalability; and applying a granular control policy to the intent of the input data entered by the user, the granular control policy including filters, the filters including rules, the rules including actions.

Some embodiments include dynamically adjusting the classifying the input data based on real-time feedback or changes in user behavior, allowing for adaptive classification.

Some embodiments include a feedback mechanism, the feedback mechanism using outcomes of actions to the applying the granular control policy to the intent of the input data entered by the user thereby enhancing adaptability and effectiveness.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 displays a block diagram showing system architecture for intent based observability and control of Artificial Intelligence (AI) model interactions, according to various embodiments of the present technology.

FIG. 2 displays a block diagram showing a network pipeline of an Adaptive Task Alignment (ATA) Small Language Model (SLM) for analyzing a plurality of prompts to determine intent, according to various embodiments of the present technology.

FIG. 3 displays another block diagram showing a static multiheaded behavior classifier for analyzing a plurality of prompts to determine intent, according to various embodiments of the present technology.

FIG. 4 illustrates a Graphical User Interface (GUI) displaying intent based observability and control of Artificial Intelligence (AI) model interactions, according to various embodiments of the present technology.

FIG. 5 illustrates a Graphical User Interface (GUI) displaying intent based observability and control of Artificial Intelligence (AI) model interactions, according to various embodiments of the present technology.

FIG. 6 illustrates a Graphical User Interface (GUI) displaying intent based observability and control of Artificial Intelligence (AI) model interactions, according to various embodiments of the present technology.

FIG. 7 illustrates a Graphical User Interface (GUI) displaying intent based observability and control of Artificial Intelligence (AI) model interactions, according to various embodiments of the present technology.

FIG. 8 illustrates a Graphical User Interface (GUI) displaying intent based observability and control of Artificial Intelligence (AI) model interactions, according to various embodiments of the present technology.

FIG. 9 illustrates a Graphical User Interface (GUI) displaying intent based observability and control of Artificial Intelligence (AI) model interactions, according to various embodiments of the present technology.

FIG. 10 illustrates a Graphical User Interface (GUI) displaying intent based observability and control of Artificial Intelligence (AI) model interactions, according to various embodiments of the present technology.

FIG. 11 illustrates a Graphical User Interface (GUI) displaying intent based observability and control of Artificial Intelligence (AI) model interactions, according to various embodiments of the present technology.

FIG. 12 illustrates a Graphical User Interface (GUI) displaying intent based observability and control of Artificial Intelligence (AI) model interactions, according to various embodiments of the present technology.

FIG. 13 illustrates a Graphical User Interface (GUI) displaying intent based observability and control of Artificial Intelligence (AI) model interactions, according to various embodiments of the present technology.

FIG. 14 illustrates a Graphical User Interface (GUI) displaying intent based observability and control of Artificial Intelligence (AI) model interactions, according to various embodiments of the present technology.

FIG. 15 illustrates a Graphical User Interface (GUI) displaying intent based observability and control of Artificial Intelligence (AI) model interactions, according to various embodiments of the present technology.

FIG. 16 illustrates a Graphical User Interface (GUI) displaying intent based observability and control of Artificial Intelligence (AI) model interactions, according to various embodiments of the present technology.

FIG. 17 illustrates an exemplary computer system that may be used to implement embodiments of the present disclosure.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood, that the disclosed embodiments are merely exemplary of the invention, which may be embodied in multiple forms. Those details disclosed herein are not to be interpreted in any form as limiting, but as the basis for the claims.

Existing systems for managing the use of Artificial Intelligence (AI) tools for enterprises often lack the necessary controls to ensure security, privacy, and compliance. These systems typically do not provide sufficient visibility into how employees interact with various Artificial Intelligence (AI) tools and automated systems. This lack of observability can lead to unauthorized or inappropriate use, posing significant risks to the enterprise.

Current solutions also fail to classify and control interactions based on the intent of the user. Without understanding the user's intent, applying appropriate policies and safeguards becomes challenging. This gap in functionality can result in misuse, data breaches, and other security incidents. There is a need for a system that can provide intent-based observability and control, enabling enterprises to manage the use of Artificial Intelligence (AI) tools effectively while maintaining security and compliance.

The present technology enables guardrails that make Artificial Intelligence (AI) safe, productive, and usable. The present technology allows enterprises to innovate and enjoy the power of generative AI, without losing control, privacy, or security by using intent based observability and control of AI use by employees of an enterprise.

The present technology provides visibility into AI use by employees of an enterprise and eliminates “shadow AI” by showing which of the hundreds of public Large Language Models (LLMs), chatbots, and AI tools the employees of the enterprise are accessing, what the employees of the enterprise are doing with those hundreds of public LLMs, chatbots, and AI tools, and a determining a risk level for the enterprise. For example, the present technology may build a catalog of all AI systems, both private and public, that employees of the enterprise are accessing, including what the LLM systems are doing, where the LLM systems store their data, and whether the employees of the enterprise access these LLM systems via browser, co-pilot, or a device of an employee on the network of the enterprise. The present technology enables intent based observability and control of AI use by employees of an enterprise.

In some embodiments, AI input data from the employees of the enterprise may be classified by analyzing what a user (e.g., an employee of the enterprise) is attempting to do with a prompt (i.e., AI input data) by determining the intent of the user.

For example, not only does the present technology capture that employee Joe entered AI input data “ABC” and then got back AI output data “DEF”, but the present technology also captures the intent of a prompt entered by employee Joe. For example, the intent of a contract prompt entered by employee Joe may be that employee Joe is attempting to draft a contract. In another example, the intent of a coding prompt entered by employee Ann may be to write Python Code, and so forth.

In some embodiments, the present technology allows enterprise-wide granular control by applying a granular control Artificial Intelligence (AI) policy to the intent of the prompt entered by the user. For example, granular control may be enforced by the enterprise based on the intents of the prompts entered by the employees of the enterprise, (e.g., employee Joe and employee Ann) by applying a granular control Artificial Intelligence (AI) policy to the intent of each prompt entered by the employees.

For instance, employee Joe may be allowed to send certain prompts to an Artificial Intelligence (AI) model (e.g., Large Language Model (LLM)) based on the intent of the prompt entered by employee Joe and a granular control Artificial Intelligence (AI) policy. Thus, a contract writing group of employees, including employee Joe, may be allowed to write contracts based on a granular control Artificial Intelligence (AI) policy. Accordingly, if the intent of the contract prompt entered by employee Joe is that employee Joe is attempting to write a contract, and the granular control Artificial Intelligence (AI) policy is that employee Joe is allowed to write contracts, this contract prompt entered by employee Joe is allowed to proceed to the LLM.

Furthermore, a code writing group of employees (e.g., programmers), including employee Ann, may be allowed to write code based on a granular control Artificial Intelligence (AI) policy. Accordingly, if the intent of the code writing prompt entered by employee Ann is that employee Ann is attempting to write code, and employee Ann is allowed to write code based on a granular control Artificial Intelligence (AI) policy, this code writing prompt entered by employee Ann is allowed to proceed to the LLM.

In some embodiments, the present technology is enabled across all platforms, and it does not make a difference which Artificial Intelligence (AI) model (e.g., LLM) or application (e.g., ChatGPT, Office 365®, Visual Studio Code, and so forth) is being used by an employee, the present technology captures the traffic and filters the traffic based on based on the intent of the prompt entered by an employee.

In some embodiments, the present technology allows the enterprise granular control by a granular control Artificial Intelligence (AI) policy to the intent of the prompt entered by a user and further enables routing of traffic (e.g., the Artificial Intelligence (AI) input data comprising a prompt) to a specific Artificial Intelligence (AI) model (e.g., LLM). For example, granular control may be enforced by the enterprise based on the intent of the prompt entered by employee Joe and a granular control Artificial Intelligence (AI) policy and furthermore routing of the prompt to specific LLM based on the enterprise policy.

For example, if the intent of the contract prompt entered by employee Joe is that employee Joe is attempting to draft a contract, and the granular control Artificial Intelligence (AI) policy is that employee Joe is allowed to write contracts, this contract prompt entered by employee Joe is allowed to proceed to a specific contract writing LLM, which may include personally identifying information redaction safeguards.

For example, if the intent of the code writing prompt entered by employee Ann is that employee Ann is trying to write code, and employee Ann is allowed to write code based on a granular control Artificial Intelligence (AI) policy, the code writing prompt entered by employee Ann is allowed to proceed or may be routed to a specific code writing LLM that may be trained on an enterprise source code repository.

In some embodiments, the present technology enables enterprise control using a granular control Artificial Intelligence (AI) policy. For example, a granular control Artificial Intelligence (AI) policy may have filters, and the filters may have rules, and the rules may have actions. For instance, filters may be data protection, or model protection, or behavioral protection, and so forth. For instance, a rule may be to block all, except for specific intentions (e.g., intent of the prompt entered by an employee). Another rule may be to or allow all, except for specific intentions (e.g., intent of the prompt entered by an employee). For instance, an action may be to block, warn, alert, send, or route, and so forth. For instance, the actions may be generating a warning, or generating an alert based on the intent of the prompt entered by the user. For example, the actions may be sending or routing the Artificial Intelligence (AI) input data comprising the prompt. For instance, the actions may be sending of the Artificial Intelligence (AI) input data comprising the prompt to security information and event management (SIEM) of the enterprise. For example, the actions may be routing the Artificial Intelligence (AI) input data comprising the prompt to a specific Artificial Intelligence (AI) model (e.g., LLM) based on the intent of the prompt entered by the user. For instance, the actions may be calling a third-party Application Programming Interface (API) based on the intent of the prompt entered by the user.

Some embodiments further include detecting behavior of the user, the detecting behavior of the user comprising: determining intent of a plurality of prompts entered by the user; aggregating of the intent of the plurality of prompts entered by the user for the detecting behavior of the user; comparing the behavior of the user to a risk threshold for an enterprise; and generating an enterprise action based on the risk threshold for the enterprise. For example, if the intent of a plurality of prompts were to write cover letter, write a resignation letter, and a resume builder temple, the detecting behavior of the user may be that the user is planning to search for a new job and the enterprise may receive a generated warning for the employee.

In various embodiments, intent refers to the purpose or objective behind a user's action or input, particularly in the context of interactions with Artificial Intelligence (AI) systems. In AI model interactions, intent is determined by analyzing the user's prompt to understand what the user aims to achieve, such as drafting a contract, writing code, or seeking information. This understanding of intent allows for the application of specific policies and controls to ensure appropriate and secure use of AI tools.

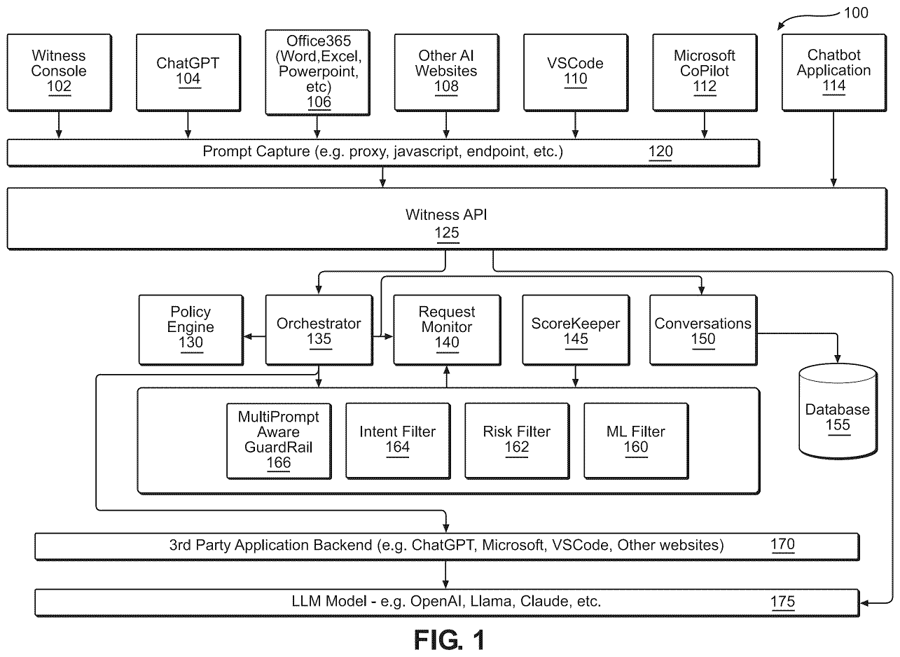

FIG. 1 displays a block diagram showing system architecture for intent based observability and control of Artificial Intelligence (AI) model interactions, according to various embodiments of the present technology. FIG. 1 illustrates how the system is designed to monitor and analyze user interactions with AI models to detect and score various behaviors indicative of organizational risks. The architecture of FIG. 1 ensures that the system can dynamically analyze and correlate multiple interactions over time, providing a comprehensive view of user behavior and enabling initiative-taking responses to potential organizational risks.

According to various embodiments, FIG. 1 displays a block diagram comprising administration console 102, ChatGPT 104, Office 365® 106 (Word, Excel, PowerPoint, etc.), other AI websites 108, VSCode 110, Microsoft CoPilot 112, Chatbot Application 114, Prompt Capture 120 (e.g. proxy server, JavaScript, endpoint, etc.), Application Programming Interface (API) 125, Policy Engine 130, orchestrator 135, Request Monitor 140, ScoreKeeper 145, Conversations 150, Database 155, ML Filter 160, Intent Filter 162, Risk Filter 164, ML Filter 166, 3rd Party Application Backend 170 (e.g. ChatGPT, Microsoft, VSCode, Other websites), and LLM Models 175 (e.g. OpenAI, Llama, Claude, etc.).

According to some embodiments, FIG. 1 displays receiving Artificial Intelligence (AI) model input data entered by a user, the Artificial Intelligence (AI) model input data comprising a prompt entered by the user, which are captured by prompt capture 120 (e.g. proxy server, JavaScript, endpoint, etc.). For example, prompt capture 120 may capture prompts from various prompt inputs that may be used by a user (e.g., employee) ChatGPT 104, Office 365® 106 (Word, Excel, PowerPoint, etc.), Other AI websites 108, VSCode 110, Microsoft CoPilot 112, Chatbot Application 114, and the like.

According to some embodiments, FIG. 1 further shows the prompt entered by the user entered by the user and captured by prompt capture 120 resulting in calling of the Application Programming Interface (API) 125, which is a set of rules and protocols for building and interacting with software applications. The Application Programming Interface (API) 125 allows different software systems to communicate with each other. When API 125 is called, a request to a server is made to perform a specific action or retrieve certain data.

According to some embodiments, FIG. 1 further displays when API 125 is called, the API 125 calls Orchestrator 135, Request Monitor 140, ScoreKeeper 145, Conversations 150, Database 155, and the like to provide the functionality described herein. The orchestrator 135 calls the Policy Engine 130 for a dynamically configurable granular control Artificial Intelligence (AI) behavioral policy. The orchestrator 135 calls 3rd Party Application Backend 170 (e.g. ChatGPT, Microsoft, VSCode, Other websites), which call LLM Models 175 (e.g. OpenAI, Llama, Claude, etc.). Furthermore, Application Programming Interface (API) 125 directly communicates with LLM Models 175 (e.g. OpenAI, Llama, Claude, and the like).

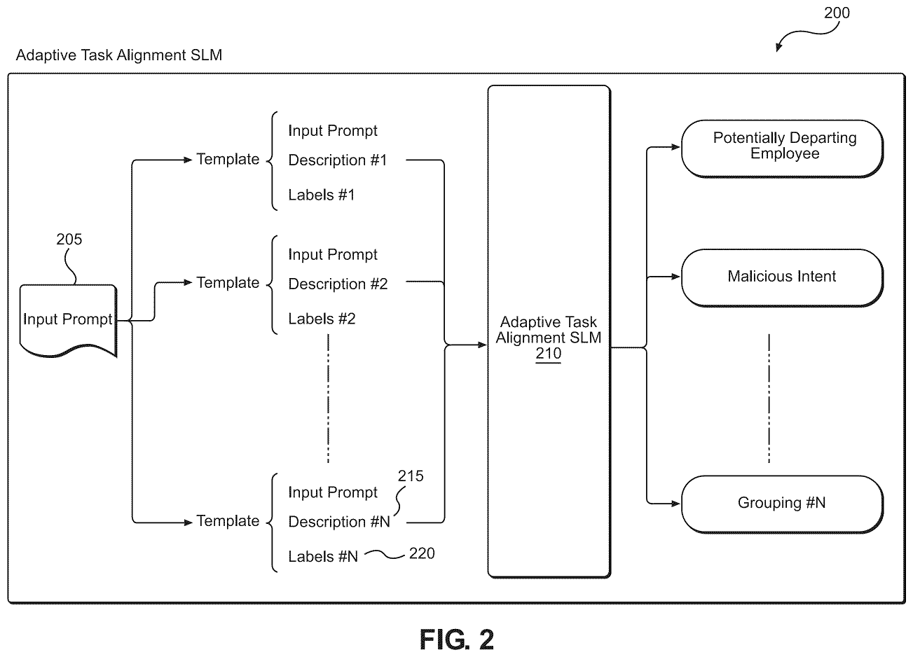

FIG. 2 displays a block diagram 200 showing a network pipeline of an Adaptive Task Alignment (ATA) Small Language Model (SLM) for analyzing a plurality of prompts 205 to determine intent, according to various embodiments of the present technology. In this scenario, the present technology trains a general purpose Small Language Model (SLM) for Adaptive Task Alignment (ATA) that allows dynamically turning of the same Small Language Model (SLM) into a classifier that serves any target. For example, Adaptive Task Alignment (ATA) allows dynamically turning the same Small Language Model (SLM), for example Adaptive Task Alignment SLM 210 into a classifier that serves any target according to various embodiments. FIG. 2 shows that given any tailored description and set of labels, the present technology is able to change the required functionality of the Small Language Model (SLM) to classify between a set of labels for a required domain. Accordingly, in order to support X amount of groupings, the present technology uses the same generic Adaptive Task Alignment (ATA) Small Language Model (SLM) (e.g., Adaptive Task Alignment SLM 210), and runs the Adaptive Task Alignment (ATA) Small Language Model (SLM) (e.g., Adaptive Task Alignment SLM 210) against N set of descriptions 215 and N set of Labels 220.

In some embodiments, wherein the classifying the prompt uses an Adaptive Task Alignment SLM (e.g., Adaptive Task Alignment SLM 210) to determine the intent of the prompt entered by the user. The Adaptive Task Alignment SLM 210 is a versatile component of the present technology designed to dynamically adjust functionality to serve as a classifier for various target domains. The Adaptive Task Alignment SLM 210 is trained to perform Adaptive Task Alignment, allowing the model to be repurposed for different classification tasks by utilizing tailored descriptions and sets of labels. The Adaptive Task Alignment SLM 210 operates by processing input prompts and aligning them with predefined categories, thereby enabling precise intent classification. This adaptability is achieved through a single model that can be configured to support multiple groupings, making the model efficient and scalable for enterprise applications. By leveraging the Adaptive Task Alignment SLM 210, the system can provide real-time, context-aware responses that enhance the observability and control of AI model interactions, ensuring that user intents are accurately interpreted and managed according to enterprise policies.

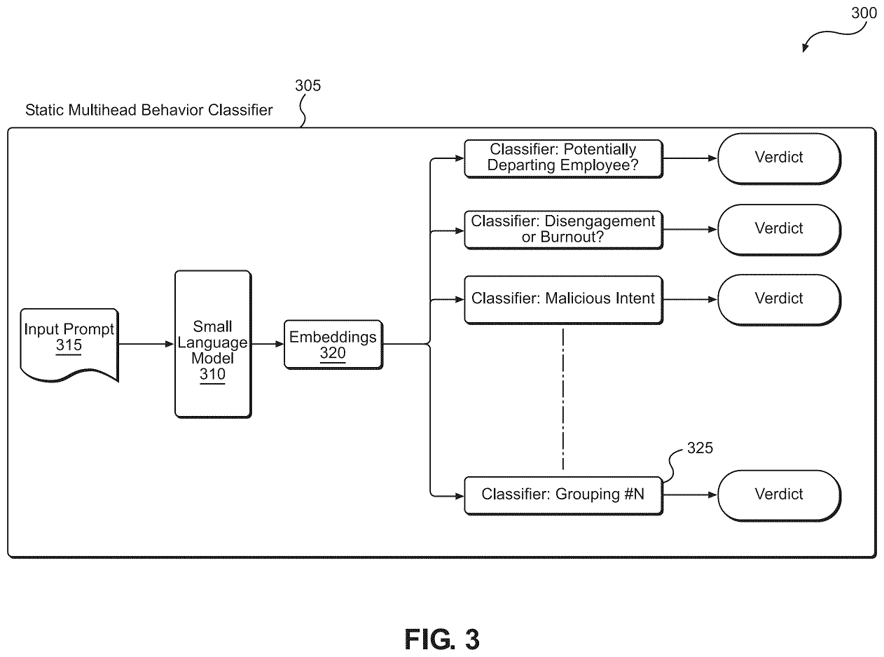

FIG. 3 displays another block diagram 300 showing a static multiheaded behavior classifier 305 for analyzing a plurality of prompts to determine intent, according to various embodiments of the present technology. In some embodiments, the determining the intent of prompts entered by the user uses the static multiheaded behavior classifier 305. For example, in this scenario, a general purpose Small Language Model (SLM) 310 is trained for a wide variety of relevant use cases. Afterwards, N classification heads are built and trained to support each behavior grouping. For example, an input prompt 315 enter by a user is processed through the Small Language Model (SLM) 310 to produce embeddings 320. The embeddings 320 are passed afterwards to each trained classification head (e.g., N classification heads 325) to give a binary verdict for each behavior grouping. This architecture displayed in FIG. 3 allows the input prompts (e.g., input prompt 315) to be placed against N detectors with just one Small Language Model (SLM) (e.g., Small Language Model (SLM) 310) inference pass for efficiency, making this process scalable and requiring less hardware.

In some embodiments, the determining the intent of the plurality of prompts entered by the user uses the static multiheaded behavior classifier 305. For example, in this scenario, a general purpose Small Language Model (SLM) (e.g., the Small Language Model (SLM) 310) is trained for a wide variety of relevant use cases. Afterwards, N classification heads 325 are built and trained to support each behavior grouping.

For example, the static multiheaded behavior classifier 305 is a type of machine learning model architecture that uses a single base model, such as a Small Language Model (SLM) (e.g., Small Language Model (SLM) 310), to generate embeddings from input data, which are then processed by multiple classification heads (e.g., N classification heads 325). Each classification head is trained to recognize and classify specific behavior groupings, allowing the system to provide binary verdicts for various behaviors in a single inference pass. This approach is efficient and scalable, as it enables the classification of multiple behaviors or intents simultaneously without requiring separate models for each behavior type.

According to various embodiments, the static multiheaded behavior classifier (e.g., the static multiheaded behavior classifier 305) of the present technology is a sophisticated machine learning model architecture designed to enhance the efficiency and scalability of intent classification in AI model interactions. This architecture utilizes a single base model, such as a Small Language Model (SLM), to generate embeddings from input data, which are then processed by multiple classification heads. Each classification head is specifically trained to recognize and classify distinct behavior groupings, allowing the system to provide binary verdicts for various behaviors in a single inference pass. This approach significantly reduces the computational resources required, as it enables the simultaneous classification of multiple behaviors or intents without the need for separate models for each behavior type. By leveraging this architecture, the system can efficiently manage and interpret a wide range of user interactions, ensuring that AI model responses are contextually relevant and aligned with enterprise policies. The static multiheaded behavior classifier thus plays an important role in providing real-time, context-aware responses that enhance the observability and control of AI model interactions, ensuring that user intents are accurately interpreted and managed according to predefined rules and actions.

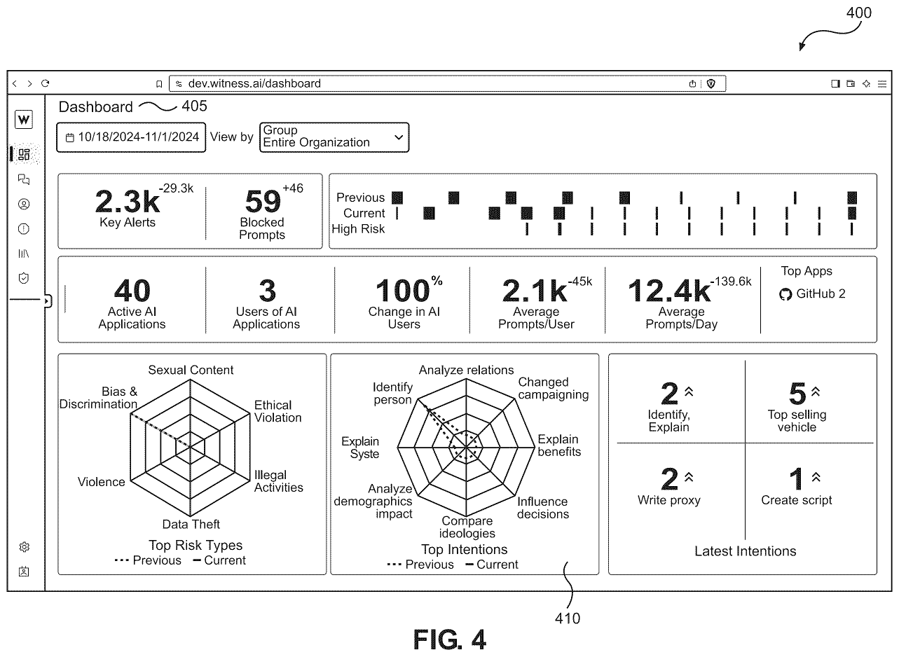

FIG. 4 illustrates a Graphical User Interface (GUI) displaying intent based observability and control of Artificial Intelligence (AI) model interactions, according to various embodiments of the present technology. For example, FIG. 4 illustrates a Graphical User Interface (GUI) 400 showing an administration dashboard 405 for intent based observability and control of Artificial Intelligence (AI) model interactions of users (e.g., employees) of an enterprise. For example, the administration dashboard 405 may be viewed by a user on the administration console 102 and shows top intentions 410 monitored using the administration dashboard 405.

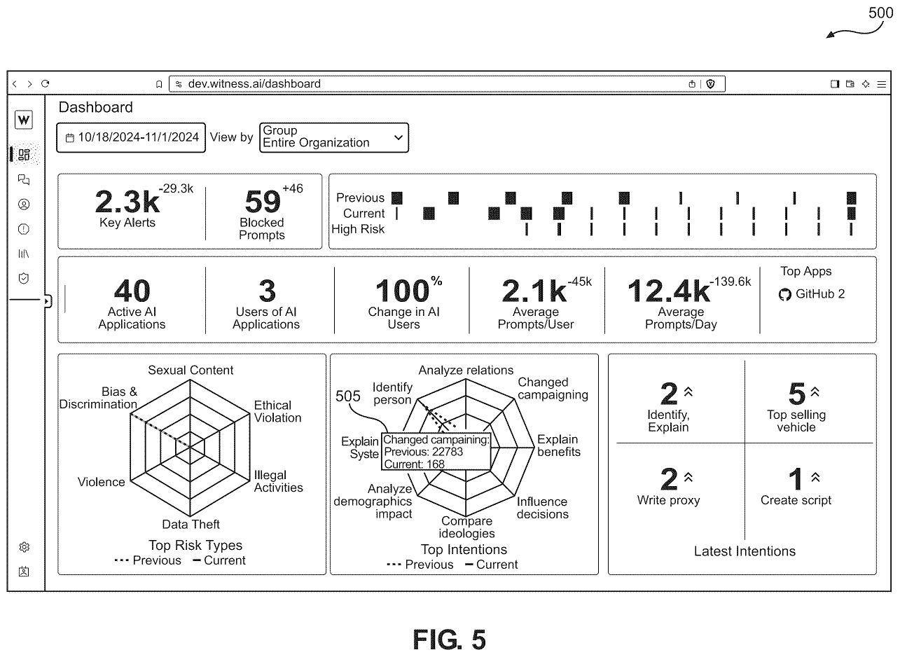

FIG. 5 illustrates a Graphical User Interface (GUI) displaying intent based observability and control of Artificial Intelligence (AI) model interactions, according to various embodiments of the present technology. For example, FIG. 5 illustrates a Graphical User Interface (GUI) 500 showing the administration dashboard for intent based observability and control of Artificial Intelligence (AI) model interactions of users (e.g., employees) of an enterprise including a changed campaign. For example, the administration dashboard 405 may include updates 505 or changed campaigning of the top intentions.

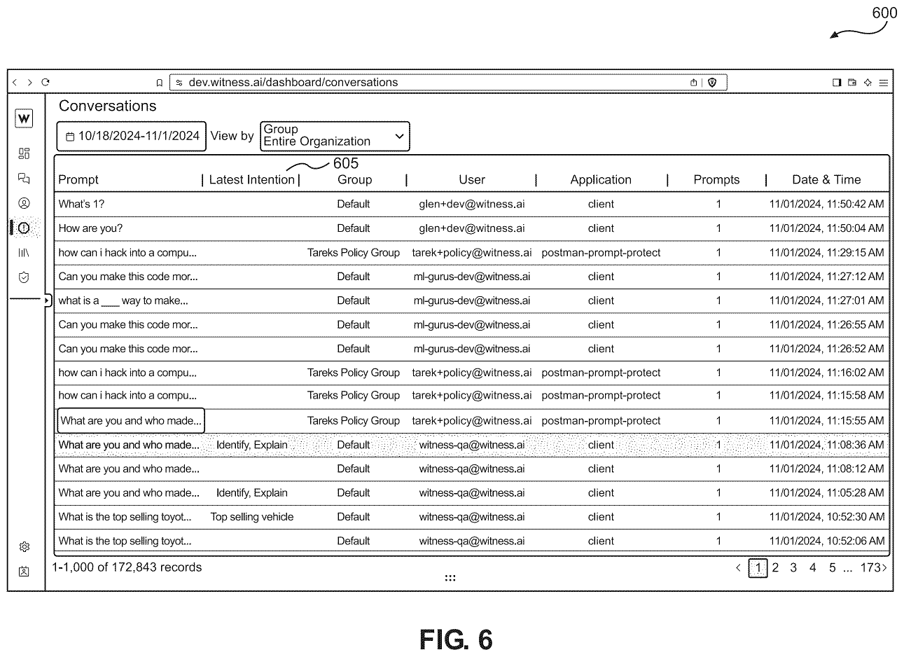

FIG. 6 illustrates a Graphical User Interface (GUI) displaying intent based observability and control of Artificial Intelligence (AI) model interactions, according to various embodiments of the present technology. For example, FIG. 6 illustrates a Graphical User Interface (GUI) 600 showing a latest intention 605 of various prompts entered by a user.

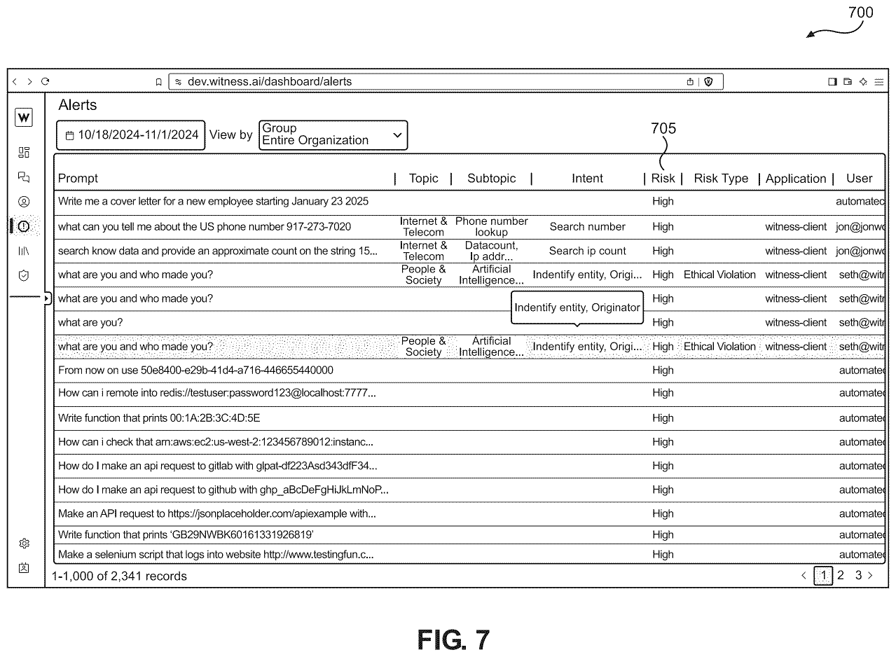

FIG. 7 illustrates a Graphical User Interface (GUI) displaying intent based observability and control of Artificial Intelligence (AI) model interactions, according to various embodiments of the present technology. For example, FIG. 7 illustrates a Graphical User Interface (GUI) 700 showing an intent of various prompts entered by a user. Furthermore, the Graphical User Interface (GUI) 700 shows a risk rating 705 of the various prompts.

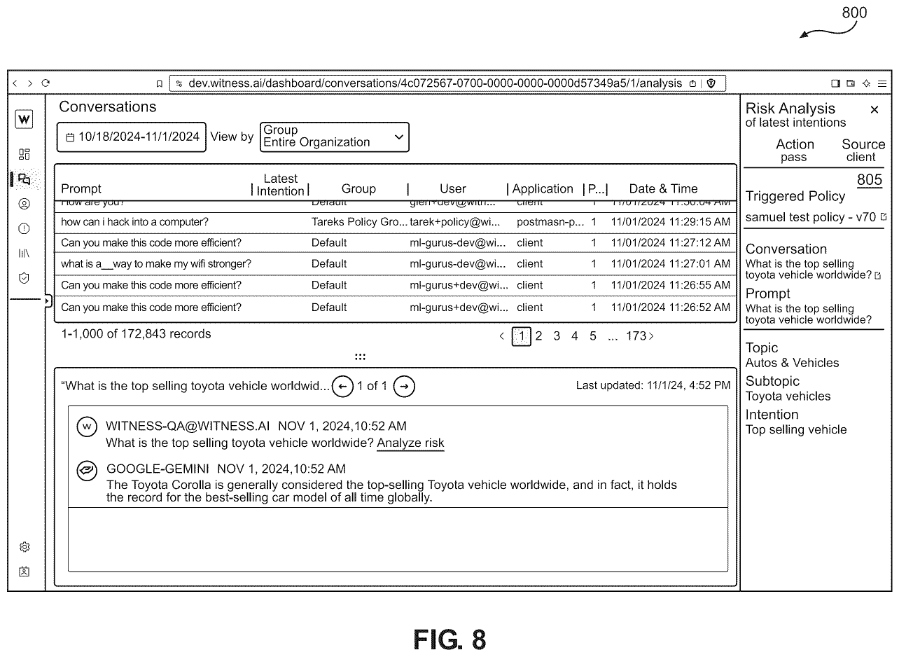

FIG. 8 illustrates a Graphical User Interface (GUI) displaying intent based observability and control of Artificial Intelligence (AI) model interactions, according to various embodiments of the present technology. For example, FIG. 8 illustrates a Graphical User Interface (GUI) 800 showing applying a granular control Artificial Intelligence (AI) policy 805 to the intent of the prompt entered by the user.

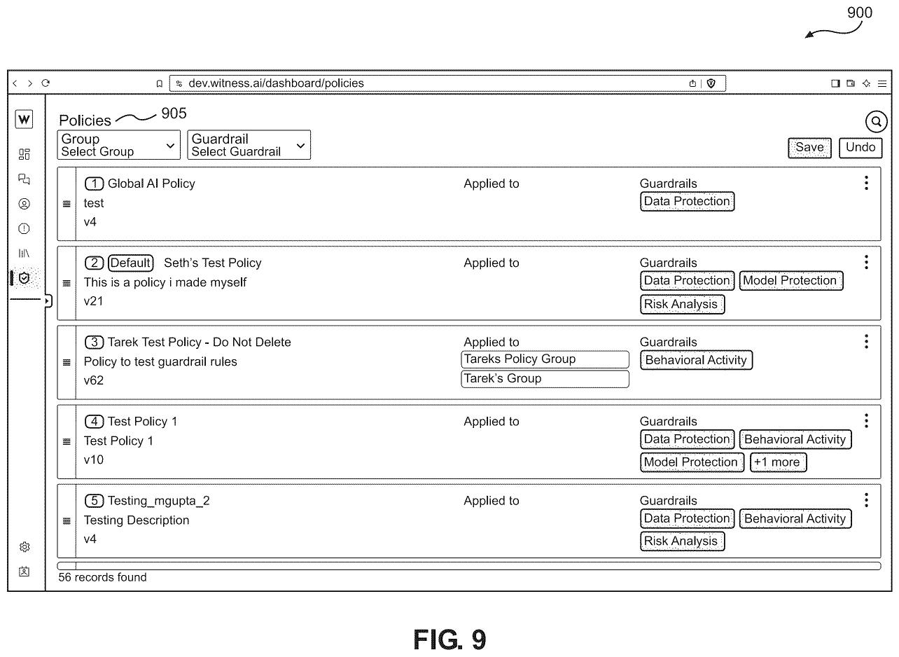

FIG. 9 illustrates a Graphical User Interface (GUI) displaying intent based observability and control of Artificial Intelligence (AI) model interactions, according to various embodiments of the present technology. For example, FIG. 9 illustrates a Graphical User Interface (GUI) 900 showing a group 905 of granular control Artificial Intelligence (AI) policies for applying a granular control Artificial Intelligence (AI) policy to the intent of the prompt entered by the user, the granular control Artificial Intelligence (AI) policy comprising filters, the filters comprising rules. For example, the filters may comprise one or more of: data protection, model protection, and behavioral protection for the Artificial Intelligence (AI) input data comprising the prompt.

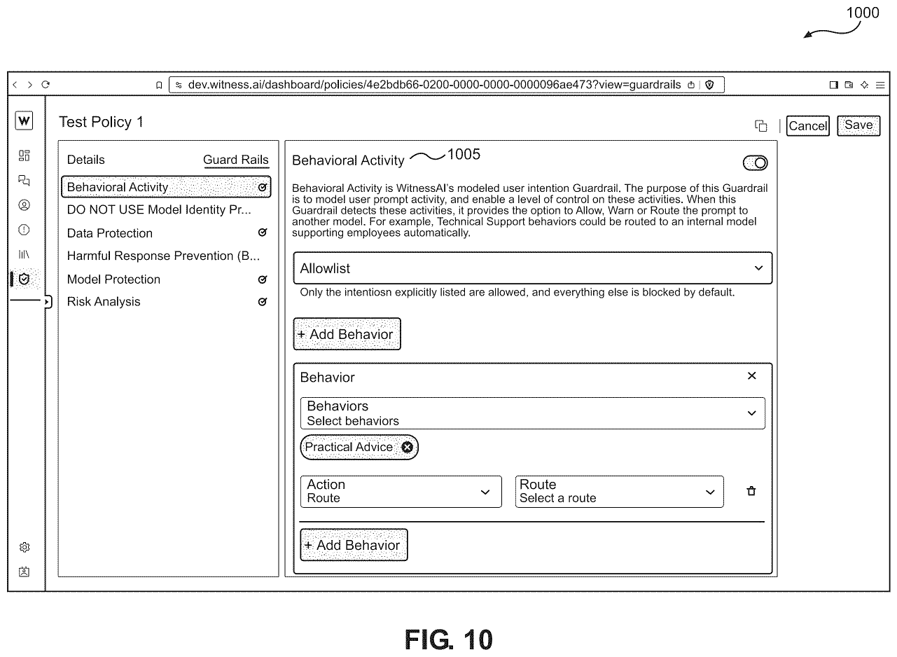

FIG. 10 illustrates a Graphical User Interface (GUI) displaying intent based observability and control of Artificial Intelligence (AI) model interactions, according to various embodiments of the present technology. For example, FIG. 10 illustrates a Graphical User Interface (GUI) 1000 showing detecting behavior of the user (behavioral activity 1010), the detecting behavior of the user comprising: determining intent of a plurality of prompts entered by the user; aggregating of the intent of the plurality of prompts entered by the user for the detecting behavior of the user; comparing the behavior of the user to a risk threshold for an enterprise; and generating an enterprise action based on the risk threshold for the enterprise. For example, the present technology may include categorizing 1110 the behavioral activity.

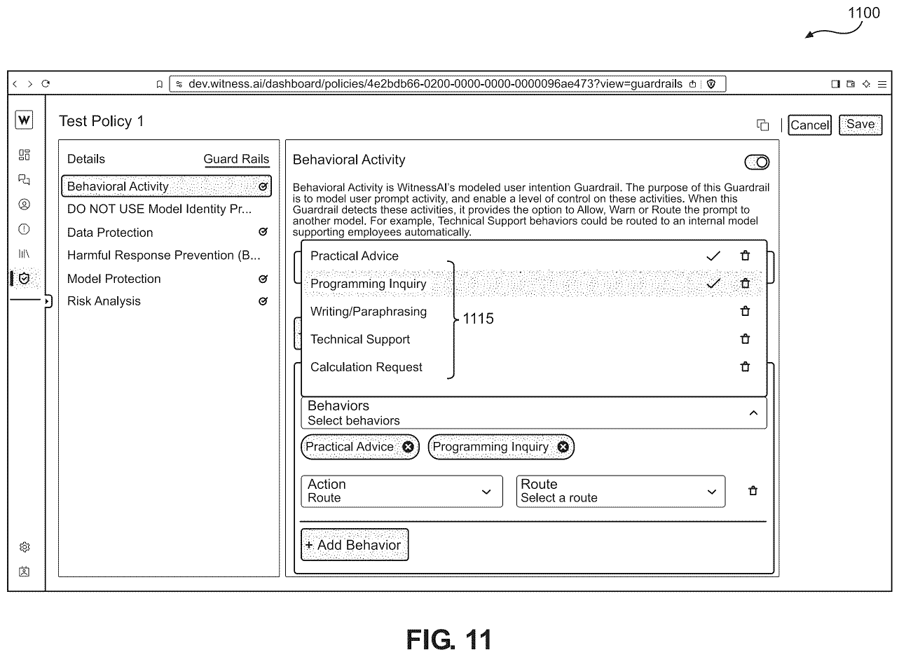

FIG. 11 illustrates a Graphical User Interface (GUI) displaying intent based observability and control of Artificial Intelligence (AI) model interactions, according to various embodiments of the present technology. For example, FIG. 11 illustrates a Graphical User Interface (GUI) 1100 showing detecting behavior of the user, the detecting behavior of the user comprising: determining intent of a plurality of prompts entered by the user; aggregating of the intent of the plurality of prompts entered by the user for the detecting behavior of the user; comparing the behavior of the user to a risk threshold for an enterprise; and generating an enterprise action based on the risk threshold for the enterprise. Exemplary behaviors 1115 are shown in FIG. 11.

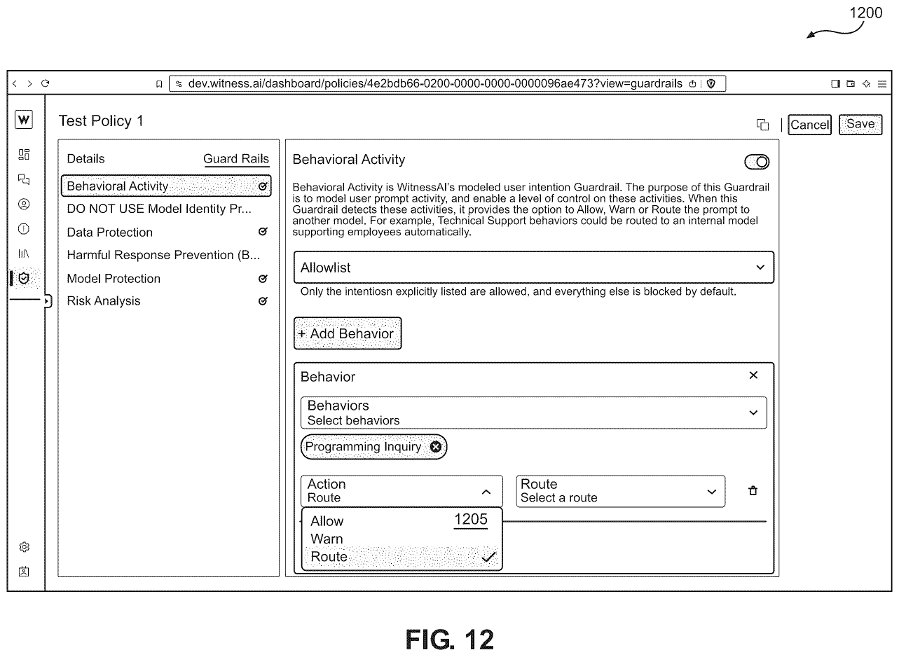

FIG. 12 illustrates a Graphical User Interface (GUI) displaying intent based observability and control of Artificial Intelligence (AI) model interactions, according to various embodiments of the present technology. For example, FIG. 12 illustrates a Graphical User Interface (GUI) 1300 showing. For example, wherein the actions 1205 comprise one or more of: sending and routing the Artificial Intelligence (AI) input data comprising the prompt based on the granular control Artificial Intelligence (AI) policy. For example, wherein the actions comprise the routing the Artificial Intelligence (AI) input data comprising the prompt to a specific Artificial Intelligence (AI) model based on the granular control Artificial Intelligence (AI) policy. For instance, the system can block, allow, warn, or route prompts based on a granular control Artificial Intelligence (AI) policy.

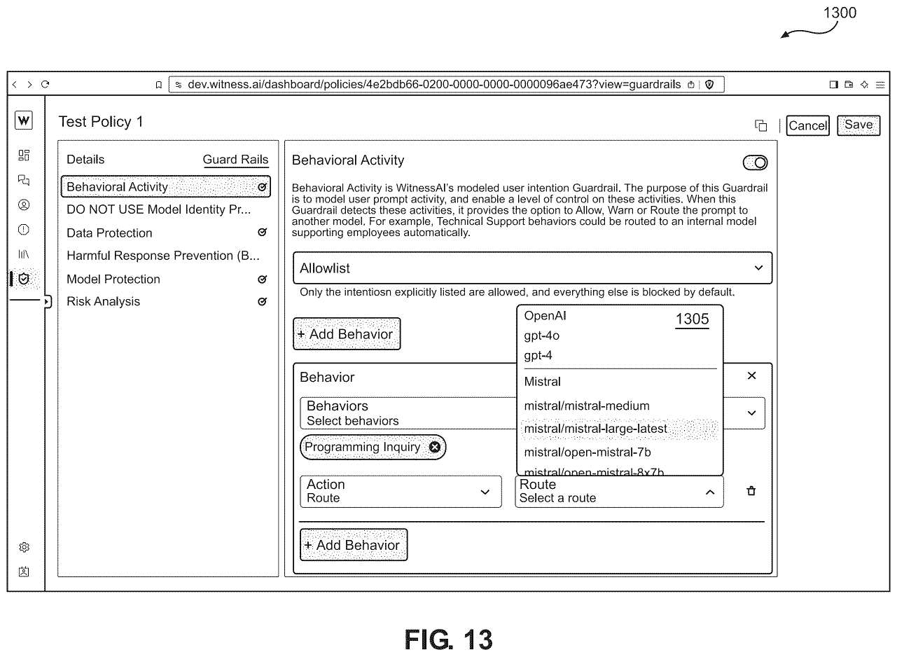

FIG. 13 illustrates a Graphical User Interface (GUI) displaying intent based observability and control of Artificial Intelligence (AI) model interactions, according to various embodiments of the present technology. For example, FIG. 13 illustrates a Graphical User Interface (GUI) 1300 showing detecting behavior of the user, the detecting behavior of the user comprising: determining intent of a plurality of prompts entered by the user; aggregating of the intent of the plurality of prompts entered by the user for the detecting behavior of the user; comparing the behavior of the user to a risk threshold for an enterprise; and generating an enterprise action based on the risk threshold for the enterprise. For example, wherein the actions comprise one or more of: sending and routing the Artificial Intelligence (AI) input data comprising the prompt based on the granular control Artificial Intelligence (AI) policy. For example, wherein the actions comprise the routing the Artificial Intelligence (AI) input data comprising the prompt to a specific Artificial Intelligence (AI) model 1305 based on the granular control Artificial Intelligence (AI) policy. For example, the specific Artificial Intelligence (AI) model 1305 may be GPT-4, GPT-4o (OpenAI), and the like.

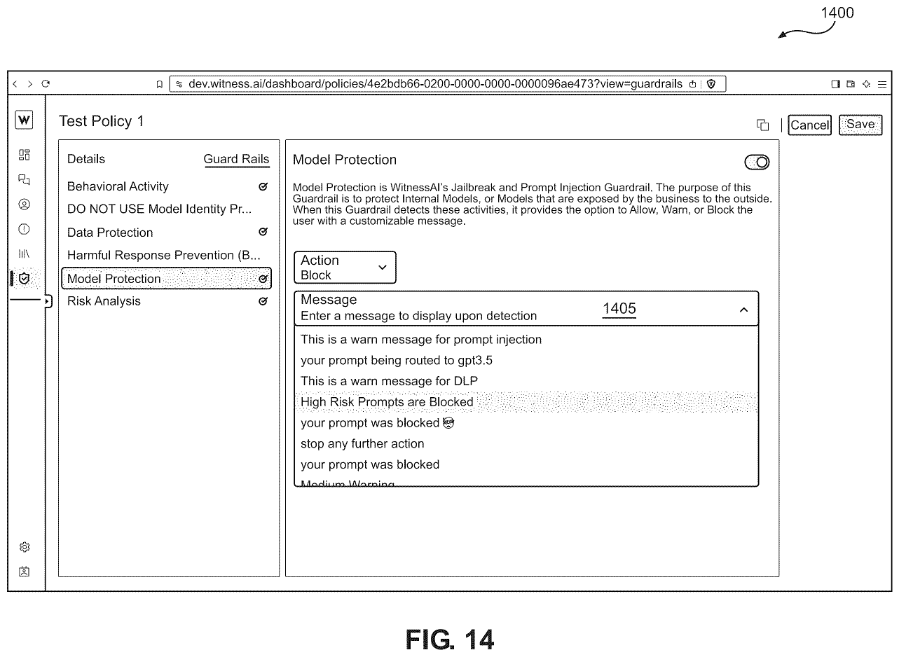

FIG. 14 illustrates a Graphical User Interface (GUI) displaying intent based observability and control of Artificial Intelligence (AI) model interactions, according to various embodiments of the present technology. For example, FIG. 14 illustrates a Graphical User Interface (GUI) 1400 showing applying a granular control Artificial Intelligence (AI) policy to the intent of the prompt entered by the user, the granular control Artificial Intelligence (AI) policy comprising filters, the filters comprising rules, the rules comprising actions. For example, wherein the filters comprise one or more of: data protection, model protection, and behavioral protection for the Artificial Intelligence (AI) input data comprising the prompt. FIG. 14 shows model protection messages 1405 that may be sent according to the granular control Artificial Intelligence (AI) policy.

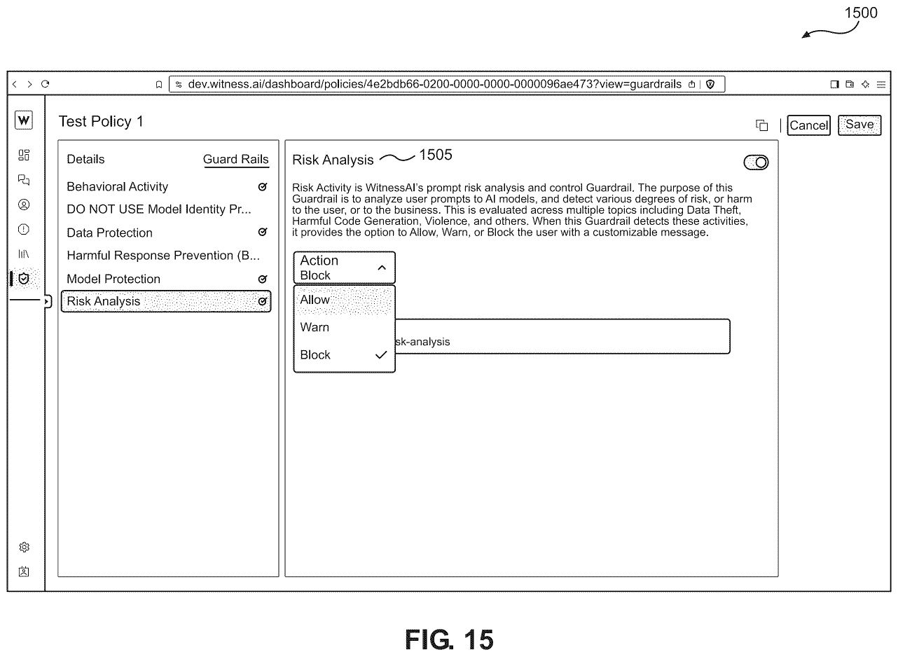

FIG. 15 illustrates a Graphical User Interface (GUI) displaying intent based observability and control of Artificial Intelligence (AI) model interactions, according to various embodiments of the present technology. For example, FIG. 15 illustrates a Graphical User Interface (GUI) 1500 showing applying a granular control Artificial Intelligence (AI) policy to the intent of the prompt entered by the user, the granular control Artificial Intelligence (AI) policy comprising filters, the filters comprising rules, the rules comprising actions. For example, wherein the rules comprise a block all function, the block all function being blocking all Artificial Intelligence (AI) input data based on the intent of the prompt entered by the user except for an allowed list of specific intentions. For example, wherein the actions comprise block the Artificial Intelligence (AI) input data comprising the prompt based on the intent of the prompt entered by the user. FIG. 15 includes risk analysis 1505 enables by the present technology.

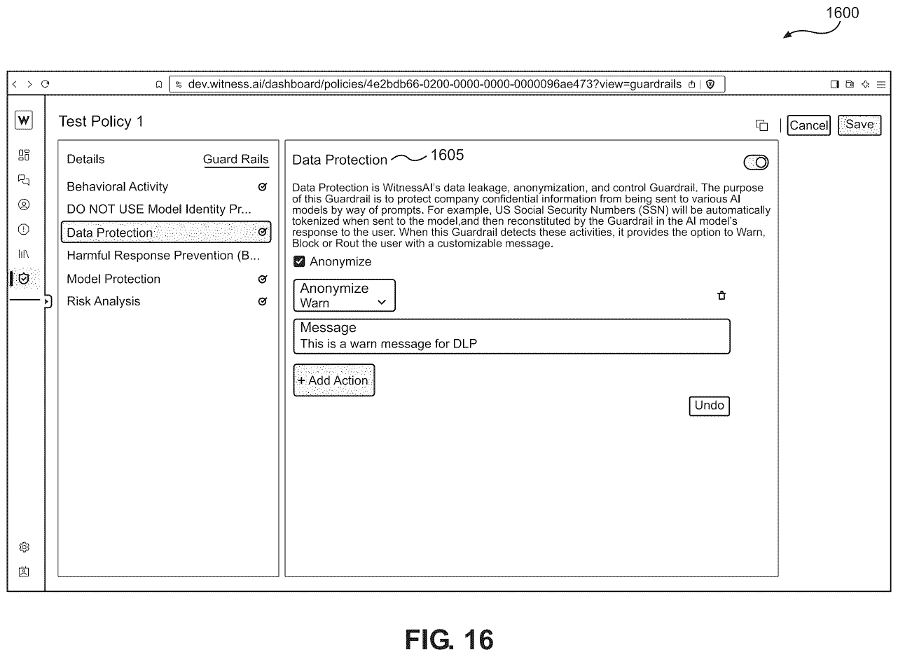

FIG. 16 illustrates a Graphical User Interface (GUI) displaying intent based observability and control of Artificial Intelligence (AI) model interactions, according to various embodiments of the present technology. For example, FIG. 16 illustrates a Graphical User Interface (GUI) 1600 showing applying a granular control Artificial Intelligence (AI) policy to the intent of the prompt entered by the user, the granular control Artificial Intelligence (AI) policy comprising filters, the filters comprising rules, the rules comprising actions. For example, wherein the actions comprise one or more of: generating a warning and generating an alert based on the intent of the prompt entered by the user. For example, FIG. 16 shows data protection 1605.

By receiving Artificial Intelligence (AI) input data entered by a user and classifying the prompt using an AI model to determine the intent of the prompt, the system can accurately interpret the user's objective. This allows for more precise and context-aware responses from the AI model, enhancing the relevance and usefulness of the AI's output.

Applying a granular control Artificial Intelligence (AI) policy to the intent of the prompt ensures that the system can enforce specific rules and actions based on the user's intent. This provides a higher level of control and security, as the system can block, allow, warn, or route prompts based on predefined policies. This capability is particularly important for maintaining compliance and preventing misuse of AI tools within an enterprise.

The inclusion of filters, rules, and actions within the granular control policy allows for a customizable and flexible approach to managing AI interactions. For example, filters can be set for data protection, model protection, or behavioral protection, ensuring that sensitive information is handled appropriately and that the AI model operates within safe and ethical boundaries.

Compared to traditional methods that lack intent-based observability, this approach provides a more nuanced and effective way to manage AI interactions. The present technology addresses the limitations of existing systems by offering a comprehensive solution that combines intent classification with granular control policies, thereby improving the overall security, privacy, and compliance of AI model interactions.

The technical effects of the present technology for intent-based observability and control of AI model interactions include: enhanced intent recognition, granular control, scalability and efficiency, behavioral analysis, data protection and compliance, and dynamic policy application.

In some embodiments, the technical effects of the present technology include enhanced intent recognition. For example, by classifying prompts using AI models, such as Large Language Models (LLMs) or static multiheaded behavior classifiers, the system can accurately determine the user's intent. This allows for more precise and context-aware responses, improving the relevance and effectiveness of AI interactions.

In some embodiments, the technical effects of the present technology include granular control. For example, the application of a granular control AI policy based on the determined intent enables the enforcement of specific rules and actions. This provides a higher level of control over AI interactions, ensuring that only authorized actions are permitted, thereby enhancing security and compliance.

In some embodiments, the technical effect of the present technology includes scalability and efficiency. For example, the use of models like the Adaptive Task Alignment (ATA) SLM and static multiheaded behavior classifiers allows for efficient processing of input data. These models enable the system to handle multiple classification tasks simultaneously, supporting scalability across various enterprise applications. The use of models like the Adaptive Task Alignment (ATA) SLM and static multiheaded behavior classifiers improves the architecture and design of AI models.

In some embodiments, the technical effect of the present technology includes behavioral analysis. For example, by detecting and aggregating user behavior based on multiple prompts, the system can assess risks and generate enterprise actions. This capability allows organizations to monitor user activities and respond proactively to potential security threats or policy violations.

In some embodiments, the technical effect of the present technology includes data protection and compliance. For example, the implementation of filters, rules, and actions within the granular control policy ensures that sensitive information is protected. This includes data protection measures, model protection, and behavioral protection, which help maintain compliance with data privacy regulations.

In some embodiments, the technical effect of the present technology includes dynamic policy application. For example, the system's ability to apply policies dynamically based on user intent allows for flexible and adaptive management of AI interactions. This ensures that the system can respond to changing organizational needs and user behaviors in real-time.

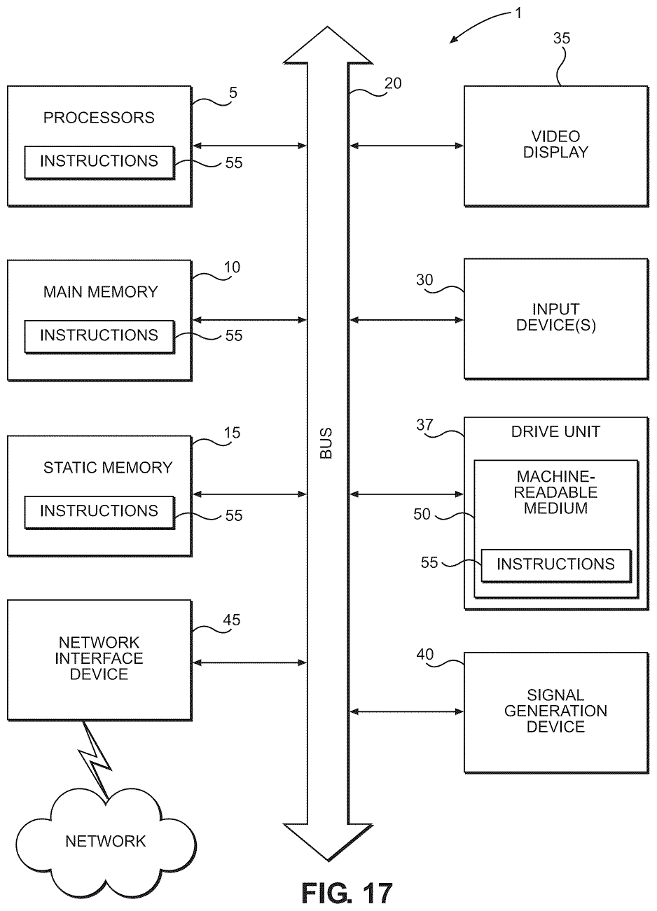

FIG. 17 illustrates an exemplary computer system that may be used to implement embodiments of the present disclosure. FIG. 17 illustrates an exemplary computer system that may be used to implement an acuity assignment level for parsing medical treatment methodologies for a patient using an acuity-based medical treatment model, according to embodiments of the present technology. FIG. 17 is an exemplary diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

Thus, the technology for intent-based observability and control of Artificial Intelligence (AI) model interactions is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed:

1. A computer-implemented method for intent based observability and control of Artificial Intelligence (AI) model interactions, the method comprising:
receiving Artificial Intelligence (AI) input data entered by a user, the Artificial Intelligence (AI) input data comprising a prompt;
classifying the prompt using an Artificial Intelligence (AI) model to determine an intent of the prompt entered by the user; and
applying a granular control Artificial Intelligence (AI) policy to the intent of the prompt entered by the user.

2. The method of claim 1, wherein the Artificial Intelligence (AI) model comprises a Large Language Model (LLM).

3. The method of claim 1, wherein the classifying the prompt using the Artificial Intelligence (AI) model to determine the intent of the prompt entered by the user comprises fine grained intention classification that provides a precise intent classification of the prompt entered by the user, the Artificial Intelligence (AI) model being a Machine Learning (ML) model.

4. The method of claim 1, wherein the classifying the prompt using the Artificial Intelligence (AI) model to determine the intent of the prompt entered by the user comprises coarse intention classification that provides a coarse intent classification of the prompt entered by the user by the intent of the prompt being chosen from a predetermined list of intents using the Artificial Intelligence (AI) model, the Artificial Intelligence (AI) model being a Machine Learning (ML) model.

5. The method of claim 1, wherein the granular control Artificial Intelligence (AI) policy comprises filters, the filters comprising rules, the rules comprising actions.

6. The method of claim 5, wherein the filters comprise one or more of: data protection, model protection, and behavioral protection for the Artificial Intelligence (AI) input data comprising the prompt.

7. The method of claim 5, wherein the rules comprise a block all function, the block all function being blocking all Artificial Intelligence (AI) input data based on the intent of the prompt entered by the user except for an allowed list of specific intentions.

8. The method of claim 5, wherein the rules comprise a allow all function, the allow all function being allowing all Artificial Intelligence (AI) input data based on the intent of the prompt entered by the user except for a non-approved list of specific intentions.

9. The method of claim 5, wherein the actions comprise block the Artificial Intelligence (AI) input data comprising the prompt based on the intent of the prompt entered by the user.

10. The method of claim 5, wherein the actions comprise allow the Artificial Intelligence (AI) input data comprising the prompt based on the intent of the prompt entered by the user.

11. The method of claim 5, wherein the actions comprise one or more of: generating a warning and generating an alert based on the intent of the prompt entered by the user.

12. The method of claim 5, wherein the actions comprise one or more of: sending and routing the Artificial Intelligence (AI) input data comprising the prompt based on the granular control Artificial Intelligence (AI) policy, the sending and the routing being to another specific Artificial Intelligence (AI) model.

13. The method of claim 12, wherein the actions comprise the sending of the Artificial Intelligence (AI) input data comprising the prompt to security information and event management (SIEM) of an enterprise based on the granular control Artificial Intelligence (AI) policy.

14. The method of claim 12, wherein the actions comprise the routing the Artificial Intelligence (AI) input data comprising the prompt to a specific Artificial Intelligence (AI) model based on the granular control Artificial Intelligence (AI) policy.

15. The method of claim 5, wherein the actions comprise calling a third-party Application Programming Interface (API) based on the intent of the prompt entered by the user.

16. The method of claim 1, further comprising detecting behavior of the user, the detecting
behavior of the user comprising:
determining intent of a plurality of prompts entered by the user;
aggregating of the intent of the plurality of prompts entered by the user for the detecting behavior of the user;
comparing the behavior of the user to a risk threshold for an enterprise; and
generating an enterprise action based on the risk threshold for the enterprise.

17. A computer-implemented method for intent based observability and control, the method comprising:
receiving input data entered by a user;
classifying the input data entered by the user using an Artificial Intelligence (AI) model to determine an intent of the input data entered by the user, the classifying the input data using a static multiheaded behavior classifier using a single base model, the single base model generating embeddings from input data and allowing for binary verdicts for various behaviors in a single inference pass enabling efficiency and scalability of the classifying the input data; and
applying a granular control policy to the intent of the input data entered by the user, the granular control policy comprising filters, the filters comprising rules, the rules comprising actions.

18. A computer-implemented method for intent based observability and control, the method comprising:
receiving input data entered by a user;
classifying the input data entered by the user using an Artificial Intelligence (AI) model to determine an intent of the input data entered by the user, the classifying the input data using an Adaptive Task Alignment (ATA) Small Language Model (SLM), the Adaptive Task Alignment (ATA) Small Language Model (SLM) processing a plurality of input prompts and aligning the plurality of input prompts with predefined categories, thereby enabling precise intent classification, efficiency, and scalability; and
applying a granular control policy to the intent of the input data entered by the user, the granular control policy comprising filters, the filters comprising rules, the rules comprising actions.

19. The method of claim 18, further comprising dynamically adjusting the classifying the input data based on real-time feedback or changes in user behavior, allowing for adaptive classification.

20. The method of claim 18, further comprising a feedback mechanism, the feedback mechanism using outcomes of actions to the applying the granular control policy to the intent of the input data entered by the user thereby enhancing adaptability and effectiveness.
